(19) United States
(12) Patent Application Publication
(10) Pub. No.: US 2005/0265630 A1
(43) Pub. Date: Dec. 1, 2005

(54) Illustration producing apparatus, illustration producing method, control program and readable recording medium

(76) Inventors: Yoshio Fukuhara, Nliza-shi (JP); Hiroshi Fujita, Tokyo (JP)

Correspondence Address: HARNESS, DICKEY & PIERCE, P.L.C., P.O. BOX 8910, RESTON, VA, 20195, US

(21) Appl. No.: 11/129,294

(22) Filed: May 16, 2005

(30) Foreign Application Priority Data
May 17, 2004 (JP) 2004-147075

(51) Int. Cl. G06K 9/36; G06K 1/00

(52) U.S. Cl. 382/276; 358/1.9

(57) ABSTRACT

An apparatus for producing an illustration comprises an omnidirectional camera of capturing an omnidirectional image, a computational processing section of converting the omnidirectional image to a line image, and a display section of displaying the line image.

This nonprovisional application claims priority under 35 U.S.C. §119(a) on Patent Application No. 2004-147075 filed in Japan on May 17, 2004, the entire contents of which are hereby incorporated by reference.

### BACKGROUND OF THE INVENTION

1. Field of the Invention

The present invention relates to an illustration producing apparatus comprising an omnidirectional camera capable of capturing, for example, information about a wide, maximum 360° horizontal and 180° vertical field of view to obtain an omnidirectional image, and a computational processing section of generating a perspective-projected image of a necessary region of the omnidirectional image and converting the perspective-projected image to an illustration. The present invention also relates to an illustration producing method, a control program for executing the method, and a readable recording medium recording the program.

2. Description of the Related Art

Such a type of conventional illustration producing apparatus requires measurement at a local site using a tape measure or the like, for example, when a road map is produced based on road conditions of a crossing at a current time.

For example, Patent Publication 1 provides an improved version of the illustration producing apparatus which obtains a local site image from electric map information which is provided from a geographic information system (GIS) via the Internet.

[Patent Publication] Japanese Laid-Open Publication No. 2001-319016.

However, in the conventional structure, when a local site drawing (e.g., a road drawing of a crossing, etc.) from the top is produced, distance measurement is required at a plurality of points of a local site. It is difficult to produce a drawing (including scaling) at the site. Measured data is brought back from the site to produce a drawing with effort.

In the case of the above-described electric map information from the geographic information system (GIS) (Patent Publication 1), it is not possible to produce a real-time local site road map corresponding to road conditions which vary from day to day or from time to time. It is highly likely that road conditions vary from day to day or from time to time, particularly at a crossing, due to work operations, accidents or the like. Unless the varying road conditions are not taken into account, necessary local site map data cannot be obtained at a time of occurrence of an accident. Accurate distance information required for documentation, such as an accident site and the like, cannot be obtained.

### SUMMARY OF THE INVENTION

An apparatus for producing an illustration according to the present invention comprises an omnidirectional camera of capturing an omnidirectional image, a computational processing section of converting the omnidirectional image to a line image, and a display section of displaying the line image. Thereby, the above-described object is achieved.

Preferably, the illustration producing apparatus of the present invention further comprises an output section of printing out the line image.

More preferably, the computational processing apparatus includes an image conversion section of converting the omnidirectional image to an actual scale based on a value calculated from characteristics of an optical system of the omnidirectional camera, and a line image processing section of converting an image converted by the image conversion section to the line image.

Even more preferably, the illustration producing apparatus of the present invention further comprises a mapping section of correcting an error due to distortion of the optical system, based on a known positional relationship of reference objects previously placed on a plurality of points on a local site to be imaged, with respect to the image converted by the image conversion section. The line image processing section converts the image mapped by the mapping section to the line image.

The present invention also provides a method for producing an illustration using the above-described illustration producing apparatus. The method comprises converting an omnidirectional image captured by the omnidirectional camera to an actual scale based on a value calculated from characteristics of the optical system, and converting an image converted to the actual scale to a line image. Thereby, the above-described object is achieved.

Preferably, the illustration producing method of the present invention further comprises correcting an error due to distortion of the optical system, based on a known positional relationship of reference objects previously placed on a plurality of points on a local site to be imaged, to perform mapping, with respect to the image convert to the actual scale. Converting the image to the line image includes converting the image mapped by the mapping section to the line image.

The present invention also provides a control program for causing a computer to execute each processing step of the above-described illustration producing method.

The present invention also provides a computer readable recording medium recording the above-described control program.

A function of the present invention having the above-described features will be described.

In the present invention, the omnidirectional camera capable of capturing, for example, information about a maximum 360° horizontal and 180° vertical field of view captures an omnidirectional image. The computational processing section converts the omnidirectional image to a line image. The display section displays the line image. Thereby, it is possible to automatically produce an illustration of a local site corresponding to road conditions with ease and accuracy.

In this case, a perspective-projected image is generated from a portion of the captured omnidirectional image. The perspective-projected image is converted to a line image (illustration).

Thus, according to the present invention, a perspective-projected image can be generated for a necessary region of a wide omnidirectional image captured by an omnidirectional camera capable of capturing a maximum 360° horizontal and 180° vertical field of view, and the perspective-projected image can be converted to a line image (illustration). Thereby, an illustration of a local site corresponding to road conditions can be obtained with ease and accuracy.

Thus, the invention described herein makes possible the advantages of providing an illustration producing apparatus of automatically producing an illustration of a local site corresponding to road conditions with ease and accuracy by capturing a wide-range image using an omnidirectional camera and processing the obtained image; an illustration producing method using the apparatus; a control program for executing the method; and a readable recording medium recording the program.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram schematically illustrating basic structure of an illustration producing apparatus according to an embodiment of the present invention.

FIG. 2 is a diagram illustrating an example in which the illustration producing apparatus of FIG. 1 is used at a crossing.

FIG. 3 is a block diagram illustrating a specific exemplary structure of the illustration producing apparatus of FIG. 1.

FIG. 4 is a perspective view specifically illustrating a portion of an omnidirectional camera of FIG. 1.

FIG. 5 is a flowchart illustrating each step in an exemplary basic operation of the illustration producing apparatus of FIG. 1.

FIG. 6 is a diagram illustrating an example of each image as a result of computation in each step of FIG. 5.

### DESCRIPTION OF THE PREFERRED EMBODIMENTS

Hereinafter, the present invention will be described by way of illustrative examples with reference to the accompanying drawings.

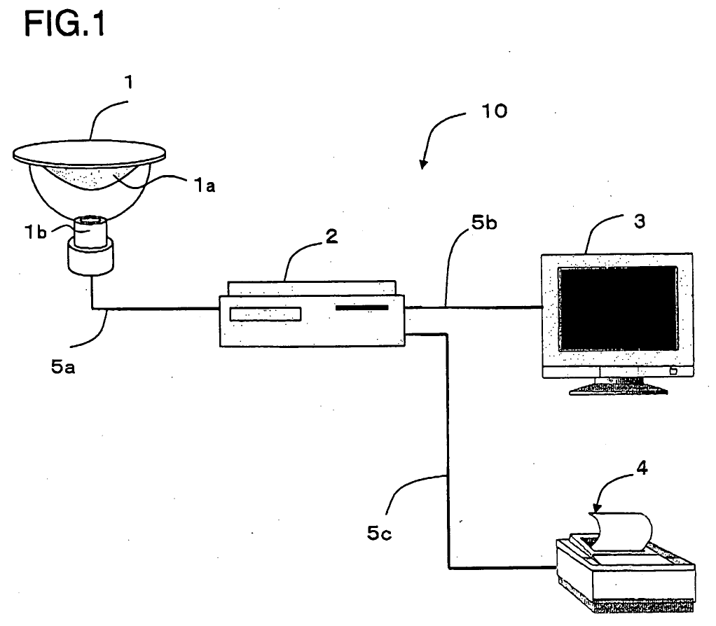

FIG. 1 is a diagram schematically illustrating a basic structure of an illustration producing apparatus according to an embodiment of the present invention.

In FIG. 1, an illustration producing apparatus 10 has an omnidirectional camera 1 capable of capturing an omnidirectional image, a computational processing section 2 of executing various computational processes with respect to image data from the omnidirectional camera 1, a display section 3 capable of displaying an image after the various computational processes, an output section 4 capable of printing an image after the various computational processes, and communication lines 5a to 5o connecting these components so that they can communicate with each other.

The omnidirectional camera 1 has an optical system 1a of projecting an optical image having a maximum 360° horizontal and 180° vertical field of view (e.g., a convex revolution body mirror, a fisheye lens, etc.), and an image capturing section 1b (imaging section) of capturing the optical image as a circular omnidirectional image (e.g., a CCD section, etc.). For example, an image capturing range is within a radius of 20 m from the omnidirectional camera 1.

The computational processing section 2 includes, for example, a personal computer (PC) capable of wired or wireless communication. The computational processing section 2 converts an image captured by the omnidirectional camera 1 to a line image.

The display section 3 includes a display screen (e.g., a liquid crystal display (LCD), a plasma display (PD), an electro-luminance display (ELD), etc.). The display section 3 displays various images, such as, for example, an image captured by the omnidirectional camera 1 and/or an image obtained by processing an image captured by the omnidirectional camera 1 using the computational processing section 2, on its display screen.

The output section 4 is of, for example, ink jet type, laser type, thermal type, video print type or the like. The output section 4 prints out on paper various images such as, for example, an image captured by the omnidirectional camera 1 and/or an image obtained by processing an image captured by the omnidirectional camera 1 using the computational processing section 2.

The communication line 5a connects the omnidirectional camera 1 and the computational processing section 2. The omnidirectional camera 1 and the computational processing section 2 communicate with each other in accordance with an NTSC scheme via the communication line 5a. An omnidirectional image captured by the omnidirectional camera 1 is transferred via the communication line 5a to the computational processing section 2.

The communication line 5b connects the computational processing section 2 and the display section 3. The computational processing section 2 and the display section 3 communicate with each other in accordance with the NTSC scheme via the communication line 5b. An omnidirectional image captured by the omnidirectional camera 1 or an image obtained by processing an omnidirectional image captured by the omnidirectional camera 1 using the computational processing section 2, to the display section 3 for displaying.

The communication line 5c connects the computational processing section 2 and the output section 4. The computational processing section 2 and the output section 4 communicate with each other in accordance with a USB scheme via the communication line 5o. An omnidirectional image captured by the omnidirectional camera 1 or an image obtained by processing an omnidirectional image captured by the omnidirectional camera 1 using the computational processing section 2, to the output section 4 for printing.

In this embodiment, the computational processing section 2 is provided separately from the other components. Alternatively, the computational processing section 2 may be incorporated with the omnidirectional camera 1 or the display section 3. The omnidirectional camera 1 and the computational processing section 2 previously have a function capable of wired or wireless data communication.

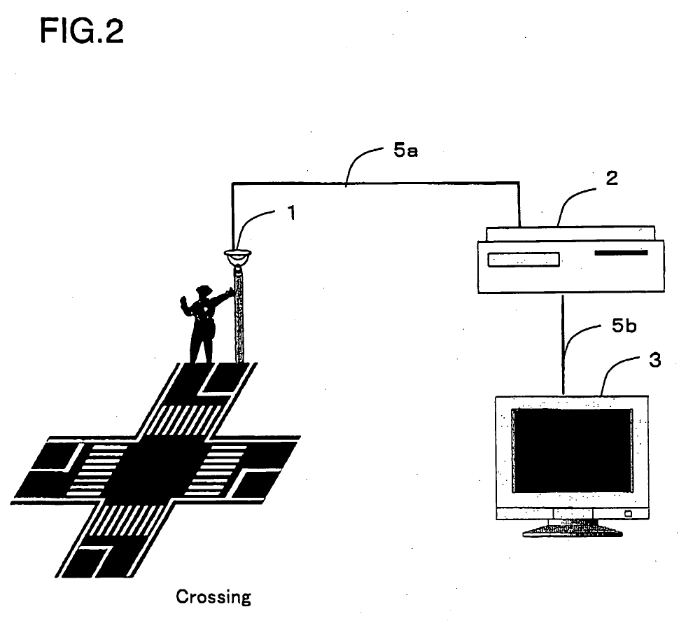

FIG. 2 is a diagram illustrating an example in which the illustration producing apparatus 1 of FIG. 1 is use data crossing. The same members as those in FIG. 1 are referenced with the same reference numerals.

In FIG. 2, for example, during on-site investigation after occurrence of a traffic accident, laying of water pipe, laying of gas pipe, laying of electricity pipe, laying of telephone line pipe, or the like, the illustration producing apparatus 10 captures an image of a local site (road) from the top using the omnidirectional camera 1, executes a predetermined computational process (e.g., line image processing, etc.) using the computational processing section 2, and displays an image obtained by the computational process on the display section 3. Note that an image before a computational process can be displayed on the display section 3. Also, the illustration producing apparatus 10 captures an image from the top using the omnidirectional camera 1, executes a predetermined computational process (e.g., a line image process, etc.), and prints out an image before or after the computational process using the output section 4.

In this embodiment, the omnidirectional camera 1 is placed at a crossing as illustrated in FIG. 2. An image of the crossing is captured from the top using the omnidirectional camera 1. The image is subjected to a predetermined computational process (e.g. a line image process, etc.) using the computational processing section 2 before the resultant illustration is displayed on the display screen of the display section 3.

Next, the illustration producing apparatus 10 of FIG. 1 will be described in more detail.

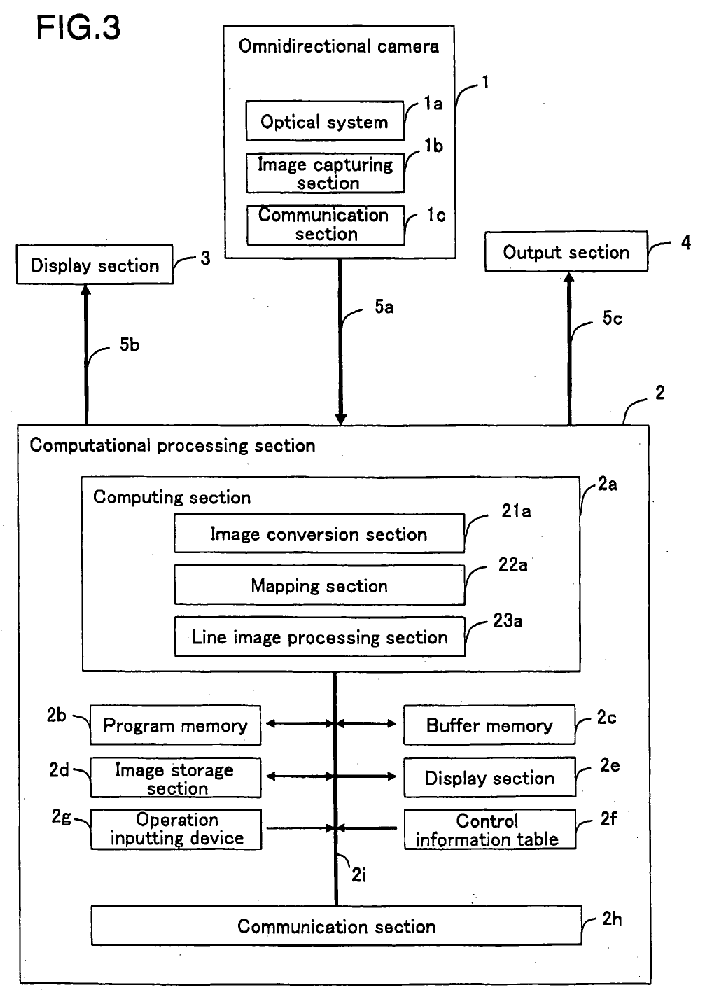

FIG. 3 is a block diagram illustrating a specific exemplary structure of the illustration producing apparatus 10 of FIG. 1. The same members as those in FIG. 1 are referenced with the same reference numerals.

As illustrated in FIG. 3, the computational processing section 2 has a computing section 2a, a program memory 2b, a buffer memory 2a, an image storage section 2d, a display section 2e, a control information table 2f, an operation inputting device 2h, a communication section 2h and a bus 2i for transmitting data of each section.

The computing section 2a includes a CPU (central processing unit; control section) of a computer. The computing section 2a has an image conversion section 21a, a mapping section 22a, and a line image processing section 23a. The image conversion section 21a converts an image captured by the omnidirectional camera 1 to an actual scale based on a value calculated from characteristics of the optical system 1a (e.g., an omnidirectional mirror). The mapping section 22a previously places reference objects having a known positional relationship on a plurality of points, and based on the positional relationship of the reference objects, corrects (calibrates) an error due to lens distortion or the like to perform mapping. The line image processing section 23a converts the mapped captured image to a line image. A function of each section is executed based on a computational program. In this manner, the computing section 2a converts omnidirectional image data from the omnidirectional camera 1 to a line image mapped to an actual scale base on computation of the characteristics of the optical system 1a (e.g., an omnidirectional mirror), and the converted image is displayed on the display screen of the display section 3.

The image on version section 21a converts an image to an actual scale based on calculation of the characteristics of the optical system 1a (e.g., an omnidirectional mirror) in accordance with an image conversion program among computation programs as control programs.

The mapping section 22a is controlled based on a mapping program among the computation programs as control programs. The mapping section 22a previously places reference objects having a known positional relationship on a plurality of points, and based on the positional relationship of the reference objects, corrects (calibrates) an error due to lens (optical system) distortion or the like to perform mapping with respect to the omnidirectional image converted in the image conversion section 21a.

The line image processing section 23a converts the omnidirectional image mapped by the mapping section 22a to a line image in accordance with a line image processing program among the computation programs as control programs.

The program memory 2b includes a readable recording medium, such as a ROM, an EPROM, an EEPROM, a floppy (registered trademark) disk, a hard disk or the like. The program memory 2b stores a computation program as a control program for activating the computing section 2a to execute various functions (procedures).

The buffer memory 2c includes a readable recording medium, such as a ROM, an EPROM, an EEPROM, a floppy (registered trademark) disk, a hard disk or the like. The buffer memory 2c temporarily stores data which to being calculated by the computing section 2a.

The image storage section 2d includes a readable recording medium, such as a ROM, an EPROM, an EEPROM, a floppy (registered trademark) disk, a hard disk or the like. The image storage section 2d temporarily stores an omnidirectional image captured by the omnidirectional camera 1 sequentially on a frame-by-frame basis.

The operation inputting device 2g is for example, a mouse, a keyboard, or the like, which enables the user to input an operational command.

The communication section 2h includes, for example, an antenna of transmitting and receiving a wireless signal, a modem (signal modulation/demodulation device), a wireless signal circuit, a communication line connection circuit, and the like. The communication section 2h can communicate with the omnidirectional camera 1, the display section 3, the output section 4, and the like.

The display section 3 has an information communication function of wired or wireless data communication. The display section 3 receives an image which is captured by the omnidirectional camera 1 and/or an image obtained by processing an image captured by the omnidirectional camera 1 using the computational processing section 2, from the computational processing section 2, and displays the image on the display screen.

The output section 4 has an information communication function of wired or wireless data communication. The output section 4 receives from the computational processing section 2 an image which is captured by the omnidirectional camera 1 and/or an image obtained by processing an image captured by the omnidirectional camera 1 using the computational processing section 2, and prints the image on paper.

The communication line 5 includes communication lines for use in transmission of data signals of the NTSC scheme and the USB scheme. The communication line 5 also includes wireless LAN of wireless communication using a short-distance air propagation signal, such as an IrDA control infrared signal or a Bluetooth electric wave signal.

The above-described computation program includes converting an omnidirectional image captured by the omnidirectional camera 1 to an actual scale by calculation based on the characteristics of the omnidirectional mirror, placing reference objects having a known positional relationship on a plurality of points and correcting (calibrating) an error due to lens distortion or the like to perform mapping with respect to the converted omnidirectional image, and converting the mapped omnidirectional image to a line image. The computation program is stored in a predetermined readable recording medium (program memory 2b). The computation program causes a computer to execute at least these steps.

In addition to the above-described steps, the computation program further includes displaying an omnidirectional image, displaying a line image, the step of outputting a line image, and the like.

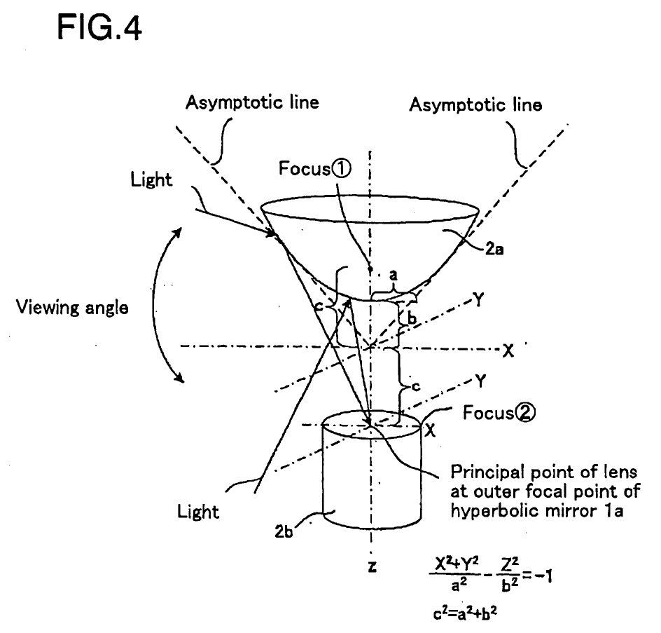

Next, the omnidirectional camera 1 of FIG. 1 will be described in more detail with reference to FIGS. 3 and 4.

The omnidirectional camera 1 has the optical system 1a, the image capturing section 1b (imaging section) including a CCD section, and a communication section 1a capable of communicating a control signal or an image signal to/from other sections using in a wired or wireless manner as illustrated in FIG. 3.

The optical system 1a includes, for example, a parabolic or hyperbolic convex revolution body mirror or fisheye lens, a cylindrical or bowl-shaped transparent member holding a CCD camera section (the image capturing section 1b), and the like. The optical system 1a projects an omnidirectional optical image having a maximum 360° horizontal and 180° vertical field of view (e.g., an optical image obtained by projecting light reflected from the convex revolution body mirror using a lens, or an optical image obtained by projecting light using the fisheye lens).

The image capturing section 1b includes, for example, a CCD camera section including an image capturing lens, a CCD section an A/D conversion circuit, and an image processing circuit. The image capturing section 1b captures an optical image projected by the optical system 1a as omnidirectional image data.

FIG. 4 is a perspective view for explaining a major structure of the optical system 1a of the omnidirectional camera 1 of FIG. 1.

In FIG. 4, the optical system 1a of the omnidirectional camera 1 has a convex revolution body mirror which is the upper sheet (a part of Z>0) of a hyperboloid of two sheets, a convex surface of the upper sheet having a mirror surface.

The hyperboloid is represented by:
{(X²+Y²)/a²}−Z²/b²=−1, and
c²=(a²+b²)
where a and b are constants which defines the shape of the hyperboloid, and c is a constant which defines the position of a focus. These expressions and constants are included in conversion information for converting an omnidirectional image to a panorama image or a perspective image, and for example, are previously stored in the program memory 2b of FIG. 3.

The convex revolution body mirror has two focuses (1) and (2). All light beams which externally approach one focus (subject light) are reflected from a surface of the optical system 1a having the convex revolution body mirror to be directed to the other focus (2).

Therefore, when a rotational axis of the convex revolution body mirror and an optical axis of an imaging capturing lens (camera lens) of the image capturing section 1b are caused to match, and a first principal point is placed at the other focus position (2), an image captured by the image capturing section 1b is an image the position of a viewing point of which does not vary depending on the direction of a viewing field where the focus (1) is a viewing point center.

When the illustration producing apparatus 10 of this embodiment thus obtained is placed and used at a crossing, the following functions and effects (1) to (4) can be achieved.
(1) A wide-range image can be captured by the omnidirectional camera 1.

(2) An image captured by the omnidirectional camera 1 is processed by calculation based on the characteristics of the omnidirectional mirror by the computational processing section 2. As a result, an image converted to an actual scale is obtained.

(3) When an image is converted, reference objects having a known positional relationship are previously placed at a local site and an error due to lens distortion or the like corrected (calibrated) to perform mapping. As a result, an image in which lens distortion or the like is corrected can be obtained.

(4) By the line image process of the computational processing section 2, a desired road illustration can be easily obtained.

Hereinafter, an operation of the illustration producing apparatus 10 thus constructed will be described in detail.

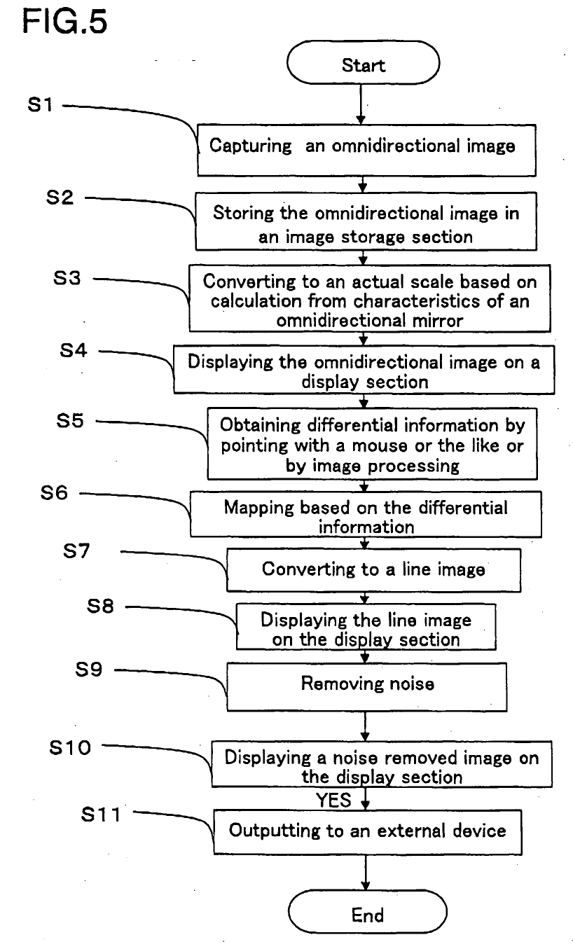

FIG. 5 is a flowchart illustrating a basic procedure of the operation of the illustration producing apparatus 10 of FIG. 1.

As illustrated in FIG. 5, in step S1, an omnidirectional image is captured using the omnidirectional camera 1. Specifically, an omnidirectional image of a maximum 360° horizontal and 180° vertical field of view of the omnidirectional camera 1 is captured.

Next, in step S2, the omnidirectional image captured by the omnidirectional camera 1 is stored in the image storage section 2d.

In step 53, the image stored in step S2 is converted to an actual scale by calculation based on the characteristics of the optical system 1a (omnidirectional mirror) using the image conversion section 21a.

In step S4, the image converted in step S3 is displayed via the display section 2e on the display screen of the display section 3.

In step 55, reference objects having a known positional relationship are previously placed at a local site, and deviation of the coordinates of positions of the reference objects on the image converted by calculation based on the characteristics of the omnidirectional mirror is pointed out using a mouse or the like, or alternatively, is subjected to matching by image processing. As a result, differential information is obtained.

In step S6, based on the mapping process program, the omnidirectional image converted in step S3 is subjected to correction (calibration) of an error due to lens distortion or the like based on the mapping information obtained in step S5 to perform mapping.

In step S7, based on the line process program, the omnidirectional image mapped in step S6 is converted to a line image.

In step S8, the image converted in step S3 is displayed via the display section 2e on the display section 2.

In step S9, during the image conversion to a line image in step S7, an unnecessary line or point (noise) is removed by pointing it out using a mouse or by a filtering process (image processing) using various noise removing filters. All unnecessary image portions can also be removed by pointing them using a mouse or the like.

In step S10, the image from which noise has been removed in step S9 is displayed via the display section 2e on the display section 2.

In step S11, the image from which noise has been removed in step S9 can also be output to the output section 4.

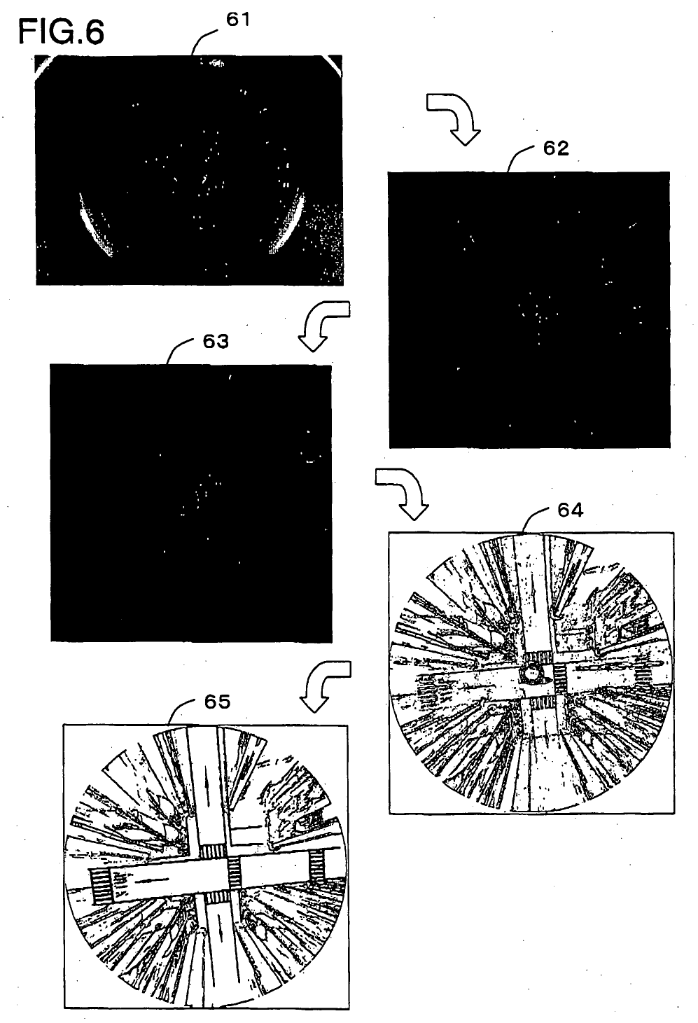

FIG. 6 is a diagram illustrating an example of each image screen as a result of the computation in each step of FIG. 5.

An image 6 is an omnidirectional image captured by the omnidirectional camera 1 in step S1.

An image 62 is an image which is obtained by converting the image stored in step S2 to an actual scale by calculation based on the characteristics of the optical system 1a (omnidirectional mirror) using the image conversion section 21a.

An image 63 is an image which is obtained by subjecting the omnidirectional image converted in step S3 to correction (calibration) of an error due to lens distortion or the like based on the mapping information obtained in step S5 to perform mapping, in accordance with a mapping process program.

An image 64 is an image which is obtained by converting the omnidirectional image mapped in step S6 to a line image in accordance with a line image process program.

An image 65 is an image which is obtained by removing an unnecessary line or point (noise) by pointing out it using a mouse or by a filtering process (image processing) using various noise removing filters.

Thus, according to the illustration producing apparatus 10 of this embodiment, for example, during on-site investigation after occurrence of a traffic accident at a crossing or the like, laying of water pipe, laying of gas pipe, laying of electricity pipe, laying of telephone line pipe, or the like, the illustration producing apparatus 10 captures an image of a local site (road) from the top using the omnidirectional camera 1, executes a predetermined computational process (e.g., line image processing, etc.) using the computational processing section 2, and displays an image obtained by the computational process on the display section 3. Also, by printing out the computation result to the output section 3, a desired illustration of the site can be easily and accurately produced.

Although the computational processing section 2 is separately provided in this embodiment, the computational processing section 2 may be integrated with the omnidirectional camera 1 or the display section 3.

The present invention can be satisfactorily applied to other applications, such as production of an illustration of circumstances of a real estate, layout of furniture in a house, and the like.

In this embodiment, the computing section 2a includes the image conversion section 21a, the mapping section 22a, and the line image processing section 23a. The image conversion section 21a converts an image captured by the omnidirectional camera 1 to an actual scale based on a value calculated from characteristics of the optical system 1a (e.g., an omnidirectional mirror). The mapping section 22a previously places reference objects having a known positional relationship on a plurality of points, and based on the positional relationship of the reference objects, corrects (calibrates) an error due to lens distortion or the like to perform mapping. The line image processing section 23a converts the mapped captured image to a line image. The present invention is not limited to this. The computing section can be constructed to have an image conversion section 21a which converts an image captured by the omnidirectional camera 1 to an image having an actual scale based on a value calculated from the characteristics of the optical system 1a (e.g., an omnidirectional mirror), and a line image conversion section 23a which converts an image converted by the image conversion section 21a to a line image.

The present invention provides an illustration producing apparatus comprising an omnidirectional camera capable of capturing, for example, information about a maximum 360° horizontal and 180° vertical field of view to obtain an omnidirectional image, and a computational processing section of generating a perspective-projected image of a necessary region of the omnidirectional image and converting the perspective-projected image to an illustration. Thus, a wide-range image is captured by the omnidirectional camera and the obtained image is processed, thereby easily and accurately producing an illustration of a local site.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

1. An apparatus for producing an illustration, comprising:
an omnidirectional camera of capturing an omnidirectional image;
a computational processing section of converting the omnidirectional image to a line image; and
a display section of displaying the line image.

2. An apparatus according to claim 1, further comprising:
an output section of printing out the line image.

3. An apparatus according to claim 1, wherein the computational processing apparatus includes:
an image conversion section of converting the omnidirectional image to an actual scale based on a value calculated from characteristics of an optical system of the omnidirectional camera; and
a line image processing section of converting an image converted by the image conversion section to the line image.

4. An apparatus according to claim 3, further comprising:
a mapping section of correcting an error due to distortion of the optical system, based on a known positional relationship of reference objects previously placed on a plurality of points on a local site to be imaged, with respect to the image converted by the image conversion section,
wherein the line image processing section converts the image mapped by the mapping section to the line image.

5. A method for producing an illustration using an illustration producing apparatus according to claim 1, comprising:
converting an omnidirectional image captured by the omnidirectional camera to an actual scale based on a value calculated from characteristics of the optical system; and
converting an image converted to the actual scale to a line image.

6. A method according to claim 5, further comprising:
correcting an error due to distortion of the optical system, based on a known positional relationship of reference objects previously placed on a plurality of points on a local site to be imaged, to perform mapping, with respect to the image convert to the actual scale,
wherein converting the image to the line image includes converting the image mapped by the mapping section to the line image.

7. A control program for causing a computer to execute each processing step of an illustration producing method according to claim 5.

8. A computer readable recording medium recording a control program according to claim 7.
